(19) United States
(12) Patent Application Publication
(10) Pub. No.: US 2026/0077611 A1
(43) Pub. Date: Mar. 19, 2026

(54) GREETING CARDS AND ENVELOPES WITH CONCEALED FEATURES

(71) Applicant: Wolf Punch, Inc., Orange, CA (US)

(72) Inventors: Travis Walker Peterson, Orange, CA (US); Taylor Gersbach, Holladay, UT (US)

(21) Appl. No.: 19/327,308

(22) Filed: Sep. 12, 2025

Related U.S. Application Data
(60) Provisional application No. 63/694,704, filed on Sep. 13, 2024.

(51) Int. Cl. B42D 15/04; B42D 15/02; B65D 27/14; B65D 27/38; G09F 1/04

(52) U.S. Cl. CPC B42D 15/045; B42D 15/022; B65D 27/14; B65D 27/38; G09F 1/04

(57) ABSTRACT

Some variants relate to greeting cards and envelopes that include hidden features to prank unsuspecting recipients. The greeting cards and envelopes can include hidden pouches that hold a plurality of objects, such as glitter. The greeting cards and envelopes can include a removable portion that, when removed by the recipient, rips open the hidden pouch to permit the plurality of objects to spill out of the hidden pouch. The greeting cards can include a hidden loudspeaker that, when the greeting card is opened by the recipient, begins emitting an audible sound for a duration of time regardless of whether the greeting card is open or closed. The greeting cards can include secondary hidden pouches holding a plurality of objects that can be ripped open to spill out the objects if the recipient attempts to destroy the greeting card to stop the emission of the audible sound by the loudspeaker.

### CROSS REFERENCE

This application claims the priority benefit of U.S. Provisional Application No. 63/694,704, filed Sep. 13, 2024, which is hereby incorporated by reference in its entirety. All applications for which a foreign or domestic priority is identified in the Application Data Sheet as filed with the present application are hereby incorporated by reference under 37 CFR 1.57.

### FIELD

This disclosure is related to greeting cards and envelopes, and more particularly, to greeting cards and envelopes with hidden features to play a prank on unsuspecting recipients.

### BACKGROUND

Sending greeting cards to friends and family is a customary gesture to commemorate an event, such as a holiday, celebration, accomplishment, or the like. The greeting card generally has a theme (e.g., images, text, etc.) congruent with the corresponding event. The greeting card is typically inserted into an envelope and mailed to the recipient.

### SUMMARY

The present disclosure relates to greeting cards and envelopes that include hidden features to prank unsuspecting recipients. The greeting cards and/or envelopes can include hidden pouches that can hold one or more objects (e.g., glitter, confetti, stickers, press-on tattoos, candy, ribbons, sheets with printed messages and/or images, toys, etc.). The greeting cards and/or envelopes can include a removable portion (e.g., tear strip) that, when removed by the recipient, opens (e.g., rips open) the hidden pouches to permit the one or more objects to spill out of the hidden pouch. For greeting cards, the removable portion can be disposed at a bottom edge of a front or rear panel such that, when removed, the plurality of objects can spill out of the hidden pouch without substantial obstruction from the front or rear panel. For envelopes, the hidden pouch can be adhered to an underside of a sealable flap of the envelope. There can be a gap in adhesive adhering the hidden pouch to the underside of the flap at perforations of the removable portion which can ease separation of the removable portion from the flap when pulled by the recipient. The envelopes and/or greeting cards can include a perforation (e.g., cross-cut perforation) to ease separation from the envelope or greeting card. The greeting cards can include a hidden controller, one or more batteries, and loudspeaker that, when the greeting card is opened by the recipient, cooperate to begin emitting an audible sound (e.g., audio recording, music, expression, voice recording, etc.) for a duration of time (e.g., until one or more batteries are expended) regardless of whether the greeting card is opened or closed. The greeting cards can include secondary hidden pouches on an exterior of or within an interior of a front or rear panel. The secondary hidden pouches can be opened (e.g., ripped open) to permit objects within to spill out if the recipient attempts to rip or otherwise destroy the greeting card to stop the emission of the audible sound by the loudspeaker.

In some variants, a greeting card is disclosed herein that is configured to permit one or more concealed objects to spill out therefrom in response to a recipient of the greeting card separating a tear strip from a panel of the greeting card. The greeting card can include a first panel. The greeting card can include a second panel rotatably coupled to the first panel. The second panel can include an inner wall, an outer wall, and/or an interior disposed between the inner wall and the outer wall. The greeting card can include a tear strip. The tear strip can be coupled to the inner wall with an upper perforation and/or a lower perforation. The upper perforation and/or lower perforation can include cross-cut perforations. The lower perforation can be disposed at a bottom edge of the second panel. The greeting card can include a pouch including one or more objects. The pouch can be disposed within the interior of the second panel and/or be coupled to the tear strip. The tear strip can be grasped and separated from the second panel by a recipient of the greeting card such that the pouch tears open to permit the one or more objects to spill out downward substantially unobstructed by the greeting card.

In some variants, the tear strip can include a grasping portion that can be grasped by the recipient.

In some variants, the grasping portion can be disposed between the first panel and the second panel.

In some variants, the greeting card can include an adhesive component that can adhere a bottom portion of the pouch to the tear strip.

In some variants, the adhesive component may not be applied at the upper perforation.

In some variants, the adhesive component may not be applied at the lower perforation.

In some variants, the greeting card can include an intermediate layer disposed at the bottom edge of the second panel between the inner wall and the outer wall.

In some variants, the lower perforation can couple a bottom edge of the intermediate layer to a bottom edge of the inner wall.

In some variants, each of the cross-cut perforations can include a horizontal portion and an angled portion.

In some variants, the angled portion can extend from an end of the horizontal portion at an obtuse angle.

In some variants, the greeting card can include a loudspeaker, a controller operatively connected to the loudspeaker, a battery configured to provide electrical power to the controller and the loudspeaker, and/or a switch coupled to the first panel and the second panel. The controller can be configured to be operable in a safe mode and a recipient mode. Rotating the first panel with respect to the second panel can cause the switch to move between a first state and a second state.

In some variants, with the controller in the safe mode, the controller can start emitting a recorded sound by way of the loudspeaker when the switch moves from the first state to the second state and/or stop emitting the recorded sound when the switch moves from the second state to the first state. With the controller in the recipient mode, the controller can start emitting the recorded sound by way of the loudspeaker when the switch moves from the first state to the second state and continue emitting the recorded sound when the switch moves from the second state to the first state until the battery is expended.

In some variants, the first panel and second panel can be in an open configuration with the switch in the first state and the first panel and second panel can be in a closed configuration with the switch in the second state.

In some variants, the controller can be configured to switch only once from the safe mode to the recipient mode.

In some variants, the greeting card can include an operational switch that can be manipulated by a user to switch the controller from the safe mode to the recipient mode such that the controller cannot be switched from the recipient mode back to the safe mode.

In some variants, the operational switch can be coupled to the controller and can be decoupled from the controller by the user to switch the controller from the safe mode to the recipient mode.

In some variants, a greeting card to prank a recipient is disclosed herein. The greeting card can include a first panel. The greeting card can include a second panel coupled to the first panel. The second panel can include an interior concealed from view. The greeting card can include a removable portion. The removable portion can be coupled to the second panel with a first perforation and/or a second perforation. The first perforation and/or the second perforation can include cross-cut perforations. The cross-cut perforations can include a horizontal portion and/or an angled portion extending from an end of the horizontal portion at an angle. The second perforation can be disposed at a bottom edge of the second panel. The greeting card can include a pouch including one or more objects. The pouch can be disposed within the interior of the second panel and/or coupled to the removable portion. The removable portion can be grasped and separated from the second panel by a recipient of the greeting card to open the pouch to permit the one or more objects to spill out.

In some variants, the removable portion can be grasped and separated from the second panel by the recipient of the greeting card to tear open the pouch.

In some variants, the removable portion can include a grasping portion that can be grasped by the recipient.

In some variants, the greeting card can include a loudspeaker, a controller operatively connected to the loudspeaker, a battery configured to provide electrical power to the controller and the loudspeaker, and/or a switch coupled to the first panel and the second panel. The controller can be operable in a safe mode and a recipient mode. Rotating the first panel with respect to the second panel can cause the switch to move between a first state and a second state.

In some variants, with the controller in the safe mode, the controller can start emitting a recorded sound by way of the loudspeaker when the switch moves from the first state to the second state and stop emitting the recorded sound when the switch moves from the second state to the first state. With the controller in the recipient mode, the controller can start emitting the recorded sound by way of the loudspeaker when the switch moves from the first state to the second state and continue emitting the recorded sound when the switch moves from the second state to the first state until the battery is expended.

In some variants, the removable portion can include a tear strip.

In some variants, an envelope to prank a recipient is disclosed herein. The envelope can include a receptacle portion including an opening into an interior configured to receive a greeting card. The envelope can include a flap rotatably coupled to the receptacle portion. The envelope can include a removable portion coupled to the flap with a first perforation and a second perforation. The envelope can include a pouch including one or more objects. The pouch can be disposed on an underside of the flap and an underside of the removable portion. The envelope can include an adhesive component adhering the pouch to the undersides of the flap and the removable portion. A first gap in the adhesive component can be disposed at the first perforation to ease separation of the removable portion from the flap. The removable portion can be grasped and separated from the flap by a recipient of the envelope such that the pouch is opened to permit the one or more objects to spill out.

In some variants, the removable portion can include a tear strip.

In some variants, a second gap in the adhesive component can be disposed at the second perforation to ease separation of the removable portion from the flap.

In some variants, the adhesive component can be double-sided tape.

In some variants, the adhesive component can be disposed at a periphery of the pouch.

In some variants, a kit is disclosed herein. The kit can include the envelope and a greeting card configured to prank a recipient. The greeting card can include a first panel. The greeting card can include a second panel coupled to the first panel. The second panel can include an interior concealed from view. The greeting card can include a removable portion. The removable portion can be coupled to the second panel with a first perforation and/or a second perforation. The first perforation and/or the second perforation can include cross-cut perforations. The cross-cut perforations can include a horizontal portion and/or an angled portion extending from an end of the horizontal portion at an angle. The second perforation can be disposed at a bottom edge of the second panel. The greeting card can include a pouch including one or more objects. The pouch can be disposed within the interior of the second panel and/or can be coupled to the removable portion. The removable portion can be grasped and separated from the second panel by a recipient of the greeting card to open the pouch to permit the one or more objects to spill out.

### BRIEF DESCRIPTION OF THE DRAWINGS

These drawings are illustrative embodiments and do not present all possible embodiments of this invention. The illustrated embodiments are intended to illustrate, but not to limit, the scope of protection. Various features of the different disclosed embodiments can be combined to form further embodiments, which are part of this disclosure.

FIG. 1 illustrates a greeting card in a closed configuration with an operational switch.

FIG. 2A illustrates the greeting card of FIG. 1 in an open configuration in which sound is emitted from a loudspeaker of the envelope.

FIG. 2B illustrates an enlarged view of a member coupled to a front panel of the greeting card of FIG. 1 extending through an opening in an inner wall of the back panel.

FIG. 3A illustrates a bottom-right corner of a back panel of the greeting card of FIG. 1.

FIG. 3B illustrates a bottom-left corner of the back panel of the greeting card of FIG. 1.

FIG. 4A illustrates the greeting card of FIG. 1 in the open configuration with a removable portion being separated from the back panel to spill out a plurality of objects from concealment within the back panel.

FIG. 4B illustrates the greeting card of FIG. 1 in the open configuration with the removable portion separated from the back panel and the plurality of objects spilled out from concealment within the back panel.

FIG. 5A illustrates the greeting card of FIG. 1 with a removable portion including cross-cut perforations coupled to the greeting card.

FIG. 5B illustrates the removable portion of FIG. 5A.

FIG. 5C illustrates the removable portion of FIG. 5A.

FIG. 5D illustrates the removable portion of FIG. 5A.

FIG. 5E illustrates a comparison of the separation of the removable portions of FIG. 1-4B and FIG. 5A-5D.

FIG. 6 illustrates an inner wall and an outer wall of the back panel of the greeting card of FIG. 1 separated to show internal components with a pouch filled with the plurality of objects.

FIG. 7 illustrates an operational switch of the greeting card of FIG. 1 separated from the envelope.

FIG. 8 illustrates an enlarged view of a controller of the greeting card of FIG. 1 with the operational switch removed to arm the envelope for pranking.

FIG. 9 illustrates the inner wall and the outer wall of the back panel of the greeting card of FIG. 1 separated to show inner components with the pouch torn open and emptied of the plurality of objects.

FIG. 10 illustrates a secondary pouch holding a plurality of objects that can be incorporated into the greeting card of FIG. 1.

FIG. 11 illustrates an envelope with a flap including a removable portion that can be separated from the flap to open the envelope.

FIG. 12A illustrates an underside of the flap of the envelope of FIG. 11 with a pouch holding a plurality of objects.

FIG. 12B illustrates the underside of the flap of the envelope of FIG. 11 with the adhesive locations to adhere the pouch to the flap indicated.

FIG. 13A illustrates the envelope of FIG. 11 with the flap adhered shut.

FIG. 13B illustrates the envelope of FIG. 11 with the removable portion being separated from the flap to spill out the plurality of objects from concealment within the pouch on the underside of the flap.

FIG. 13C illustrates the envelope of FIG. 11 with the removable portion separated from the flap and the plurality of objects spilled out from concealment within the pouch on the underside of the flap.

FIG. 13D illustrates the underside of the flap of the envelope of FIG. 11 with the removable portion separated from the flap and pouch torn open and emptied of the plurality of objects.

### DETAILED DESCRIPTION OF EMBODIMENTS

Example embodiments described herein have several features, no single one of which is indispensable or solely responsible for their desirable attributes. Without limiting the scope of the claims, some of the advantageous features of some embodiments will be described.

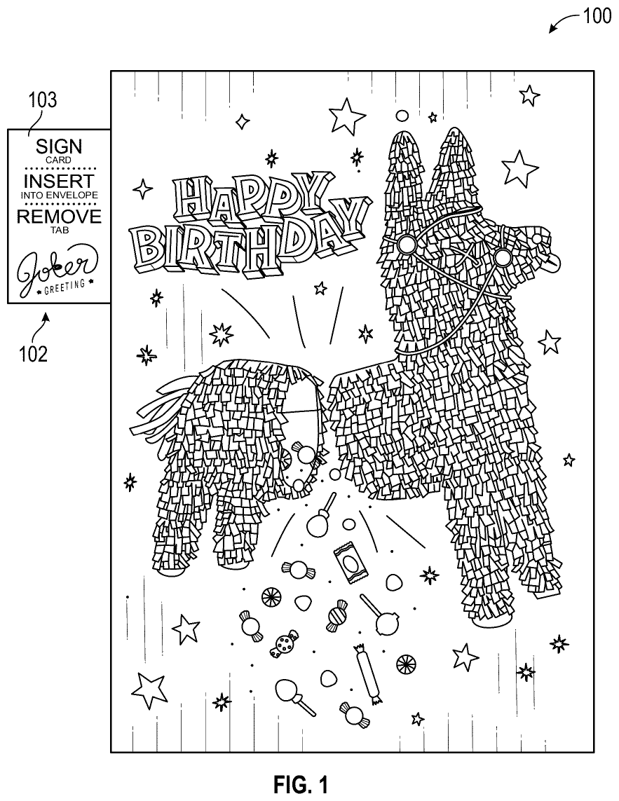

FIG. 1 illustrates a greeting card 100, which can also be referred to as a message card and/or card. The greeting card 100 can be placed into an envelope and mailed to a recipient for a variety of reasons, which can include commemorating an event such as a holiday, celebration, accomplishment, or the like. The greeting card 100 can include a theme (e.g., art, images, graphics, text, etc.) congruent with the corresponding event (e.g., birthday). The greeting card 100 can be formed with one or more sheets (e.g., paper, heavy paper stock, cardboard, and/or another medium).

The greeting card 100 can include one or more hidden features to prank the recipient of the greeting card 100. For example, a concealed loudspeaker of the greeting card 100 can, when the greeting card 100 is opened, begin emitting an audible sound (e.g., music, expression, voice recording, etc.) for a duration of time (e.g., until one or more batteries are exhausted) regardless of whether the greeting card 100 subsequently remains opened or is closed. The greeting card 100 can include an operational switch 102, which can also be referred to as a primary operational switch, to arm the greeting card 100 for a prank operation (e.g., switch operational modes from a safe mode to a prank mode). With the operational switch 102 coupled to the greeting card 100 (e.g., safe mode), the concealed loudspeaker can emit the audible sound when opened but cease when closed. With the operational switch 102 decoupled from the greeting card 100 (e.g., prank or recipient mode), the concealed loudspeaker can begin emitting the audible sound when initially opened after decoupling the operational switch 102 and continue emitting the audible sound regardless of whether the greeting card 100 is subsequently open or closed for a duration of time (e.g., until one or more batteries are exhausted). The operational switch 102 can include a grasping portion 103 (e.g., tab, flap) that can be held and pulled by the sender of the greeting card 100 prior to mailing to the recipient to arm the greeting card 100 for pranking (e.g., configured the greeting card 100 in prank or recipient mode). The decoupling of the operational switch 102 from the greeting card 100 can alter an electrical circuit of a concealed controller of the greeting card 100 that controls the loudspeaker such the greeting card 100 is in the prank or recipient mode as described herein.

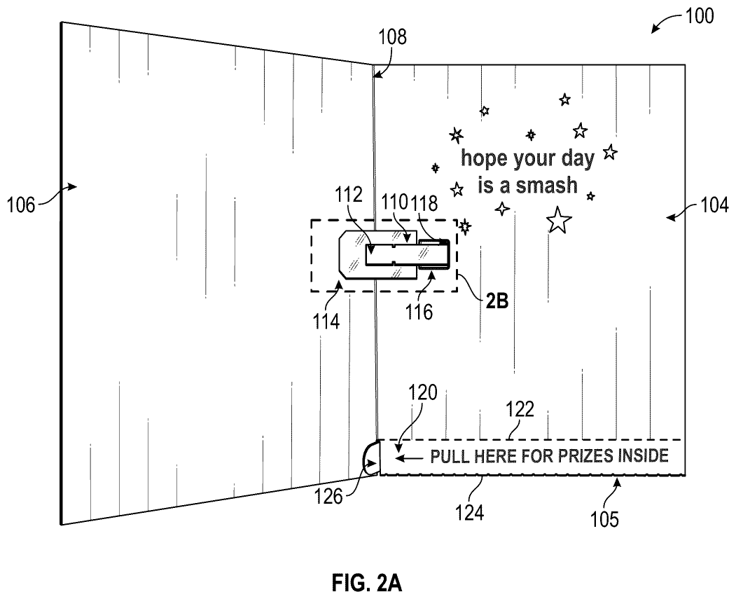

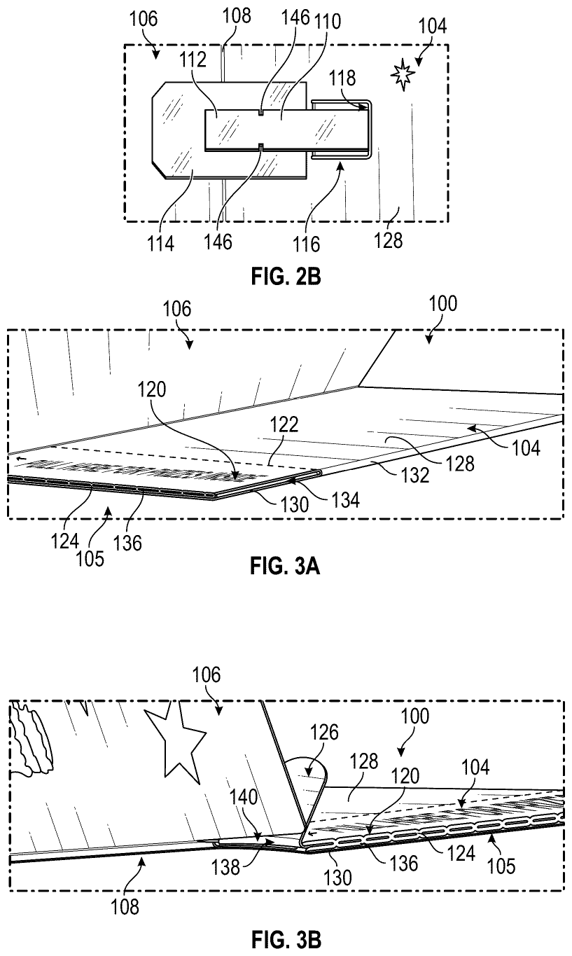

FIG. 2A illustrates the greeting card 100 in an open configuration. As shown, the greeting card 100 can include a front panel 106 and a back panel 104. A fold line 108 can be disposed between the front panel 106 and the back panel 104 to facilitate opening and closing the greeting card 100. The front panel 106 and/or back panel 104 can include indicia (e.g., graphics, images, text, art, etc.) to convey a visual message and/or sentiment.

The greeting card 100 can include a mechanism to trigger a loudspeaker of the greeting card 100 to begin emitting the audible sound. The mechanism can trigger a controller, which can be concealed within the front panel 106 and/or back panel 104, to cause a loudspeaker, which can be concealed within the front panel 106 and/or back panel 104, to begin emitting the audible sound. For example, as illustrated in FIG. 2B, the greeting card 100 can include a member 110 (e.g., strip, ribbon, arm, electrical insulator). The member 110 can include a first portion 112 (e.g., first end). The first portion 112 can be coupled (e.g., adhered) to the front panel 106, which can include being coupled to the front panel 106 proximate the fold line 108. For example, the first portion 112 can be coupled to the front panel 106 by way of an adhesive component 114 (e.g., tape, double-sided tape). The member 110 can extend from the front panel 106 into an interior 118 of the back panel 104 by way of an opening 116 of the back panel 104 to interact with a controller disposed inside the interior 118 of the back panel 104 When the greeting card 100 is opened, the relative movement between the front panel 106 and the back panel 104 can move the member 110 with respect to the back panel 104 (e.g., pull more of the member 110 out of the interior 118 of the back panel 104) to reconfigure the controller to start emitting the audible sound by way of the loudspeaker. If the operational switch 102 is still coupled to the greeting card 100, the relative movement between the front panel 106 and the back panel 104 when the greeting card 100 is closed can move the member 110 with respect to the back panel 104 (e.g., more of the member 110 can be advanced into the interior 118 of the back panel 104) to reconfigure the controller to stop emitting the audible sound by way of the loudspeaker. If the operational switch 102 is not coupled to the greeting card 100 (e.g., the greeting card 100 is in the prank or recipient mode), the controller, despite the movement of the member 110 from closing the greeting card 100, can continue emitting the audible sound by way of the loudspeaker for a duration of time (e.g., until one or more batteries expires). The member 110 can include notches 146, which can be disposed on opposing lateral sides of the member 110, to facilitate bending of the member 110 as the greeting card 100 is opened and/or closed. In some variants, the first portion 112 of the member 110 can be coupled to the back panel 104, and the member 110 can extend into an interior of the front panel 106 by way of an opening to interact with a controller disposed within the front panel 106 that controls a loudspeaker configured to emit the audible sound. The member 110 can be an electrical insulator that can be moved by opening and closing the greeting card 100 to permit electrical conduction between components of the controller or interrupt electrical conduction between components of the controller.

The back panel 104 can include a removable portion 120 (e.g., tear strip), as illustrated in FIG. 2A, that can be separated (e.g., torn) from the back panel 104 to permit one or more concealed objects (e.g., glitter, confetti, stickers, press-on tattoos, candy, ribbons, sheets with printed messages and/or images, toys, etc.) to spill out of inside the back panel 104 (e.g., interior 118 of the back panel 104, pouch disposed inside the back panel 104). The removable portion 120 can span from one lateral side of the back panel 104 to the other (e.g., from one longitudinal edge of the back panel 104 to the other longitudinal edge). The removable portion 120 can be disposed at a bottom of the back panel 104, which can include being disposed at a bottom edge 105 of the back panel 104.

The removable portion 120 can include a grasping portion 126 (e.g., tab, flange, flap). The grasping portion 126 can be disposed at an end portion (e.g., edge) of the removable portion 120, which can include an inside end portion or an outside end portion. The grasping portion 126 can include a rounded shape, which can decrease a likelihood that the grasping portion 126 will inadvertently catch on something and prematurely decouple the removable portion 120 from the back panel 104. The removable portion 120 can include instructions directing the recipient of the greeting card 100 to decouple the removable portion 120 from the back panel 104 which can include pulling the grasping portion 126. The grasping portion 126 can be disposed between the back panel 104 and front panel 106 when the greeting card 100 is closed. The grasping portion 126 can extend from the removable portion 120 to between the back panel 104 and front panel 106. The grasping portion 126 can extend away from the removable portion 120 with the greeting card 100 opened. The grasping portion 126 can be coupled (e.g., adhered) to an interior surface of the removable portion 120 and extend around the inner lateral end of the removable portion 120 to be accessible to the recipient.

The removable portion 120 can include one or more perforations to ease decoupling from the back panel 104. For example, the removable portion 120 can include an upper perforation 122 and/or a lower perforation 124. The upper perforation 122 and/or lower perforation 124 can span from one lateral side of the back panel 104 to the other (e.g., from one longitudinal edge of the back panel 104 to the other longitudinal edge). The upper perforation 122 and lower perforation 124 can be oriented parallel relative to each other. The lower perforation 124 can be disposed at the bottom edge 105 of the back panel 104. By positioning the lower perforation 124 at the bottom edge 105 of the back panel 104, the path of one or more objects spilling out of the interior of the back panel 104 can be substantially unobstructed by the greeting card 100.

As shown in FIG. 3A, the back panel 104 can include a plurality of walls. For example, the back panel 104 can include an inner wall 128 and an outer wall 130. The inner wall 128 can include the removable portion 120. In some variants, the removable portion 120 may be formed in the inner wall 128. For example, the removable portion 120 can be coupled to the inner wall 128 by the upper perforation 122. The inner wall 128 and the outer wall 130 can be joined together by a fold 132 at an outside lateral edge of the back panel 104. The fold 132 can extend along the outside lateral edge of the back panel 104 but, in some variants, may not extend along the removable portion 120 (e.g., may not extend below the upper perforation 122 of the removable portion 120). For example, a gap 134 may separate the removable portion 120 of the inner wall 128 and the outer wall 130, which may ease separation of the removable portion 120 from the back panel 104.

The back panel 104 can include an intermediate layer 136 (e.g., insert, flange). The intermediate layer 136 can be disposed between at least portions (e.g., bottom portions) of the inner wall 128 (e.g., removable portion 120) and the outer wall 130. The removable portion 120 and intermediate layer 136 can be coupled together by way of the lower perforation 124. For example, bottom edges of the removable portion 120 and intermediate layer 136 can be coupled together by way of the lower perforation 124. The intermediate layer 136 can be disposed at the bottom edge 105 of the back panel 104. The removable portion 120, intermediate layer 136, and/or bottom of the outer wall 130 can extend to (e.g., form) the bottom edge 105 of the back panel 104. The intermediate layer 136 can be adhered to an inside surface of the outer wall 130. In some variants, the intermediate layer 136 does not extend to one or more outside edges of the back panel 104. For example, the intermediate layer 136 may, in some variants, not block the gap 134 at the outer lateral side of the back panel 104. The intermediate layer 136 may, in some variants, not block a gap 138 between the removable portion 120 and the outer wall 130 at the inner lateral side of the back panel 104. As shown in FIG. 3B, a gap 140 (e.g., cutout, space) can separate bottom inside lateral sides of the back panel 104 (e.g., outer wall 130 and/or removable portion 120) and the front panel 106. The grasping portion 126 can be disposed at and/or proximate the gap 140. The gap 140 can be aligned with the fold line 108 of the greeting card 100. In some variants, a bottom edge of the removable portion 120 can be coupled to a bottom edge of the outer wall 130 with the lower perforation 124. For example, the back panel 104 can omit the intermediate layer 136 and a bottom edge of the removable portion 120 can be coupled to a bottom edge of the outer wall 130 with the lower perforation 124.

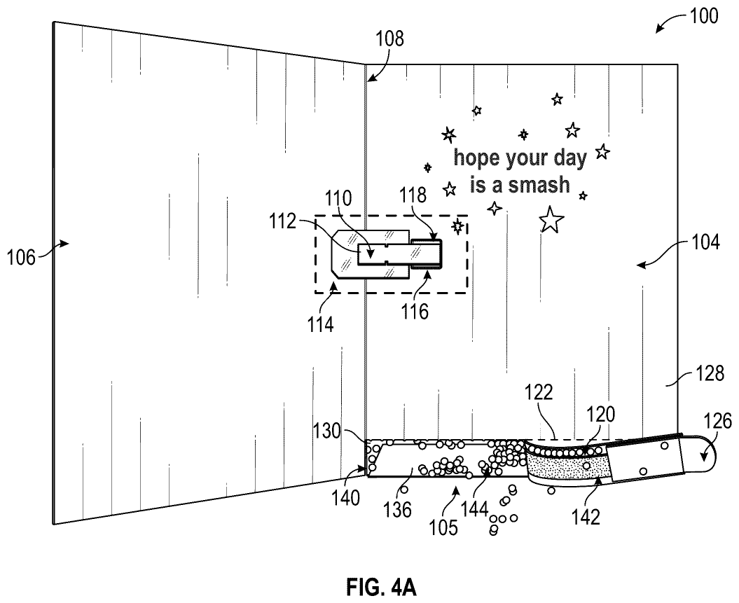

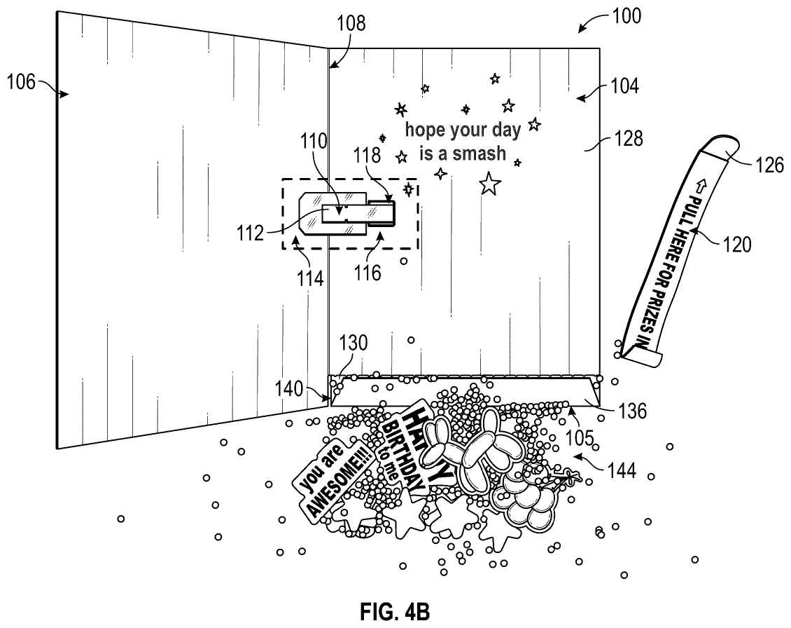

As illustrated in FIG. 4A, the removable portion 120 can be grasped (e.g., at the grasping portion 126) and pulled (e.g., pulled away from the back panel 104 and in a general direction of the outside lateral edge of the back panel 104) by the recipient to decouple (e.g., tear) the removable portion 120 from the back panel 104. For example, the upper perforation 122 and lower perforation 124 can be torn by the recipient pulling the removable portion 120, which can separate the removable portion 120 from the inner wall 128 and/or intermediate layer 136. The removable portion 120 can be coupled (e.g., adhered) to a bottom portion 142 of a pouch or other receptacle of one or more objects disposed inside the back panel 104 (e.g., between the inner wall 128 and the outer wall 130) such that, as the removable portion 120 is decoupled from the back panel 104, the pouch or other receptacle is opened (e.g., torn open) at the bottom portion 142 to allow the one or more objects 144 (e.g., glitter, confetti, stickers, press-on tattoos, candy, ribbons, sheets with printed messages and/or images, toys, etc.) to spill out. The removable portion 120 can be pulled by the recipient until the removable portion 120 is completely separated from the back panel 104 (e.g., inner wall 128 and/or outer wall 130) as illustrated in FIG. 4B. The one or more objects 144 can begin spilling out of the back panel 104 as the removable portion 120 is being decoupled and the pouch or other receptacle opened (e.g., torn open). In some variants, the intermediate layer 136 and/or inner surface of the outer wall 130 can include a hidden indicia (e.g., art, images, graphics, text, etc.) that is revealed when the removable portion 120 is separated from the back panel 104. As described herein, the positioning of the removable portion 120 at the bottom edge 105 of the back panel 104 (e.g., the lower perforation 124 at the bottom edge 105) can enable the one or more objects 144 to fall substantially unobstructed out of the interior of the back panel 104 when the removable portion 120 is being separated from the back panel 104.

In some variants, the front panel 106 can include a removable portion 120 (e.g., tear strip), instead of or in addition to the back panel 104, that can be separated from the front panel 106 to permit one or more concealed objects to spill out of a hidden pouch or other receptacle within the front panel 106. The removable portion 120 can be disposed at a bottom edge of the front panel 106 such that the one or more hidden objects can spill out of the hidden pouch without substantial obstruction from the greeting card 100.

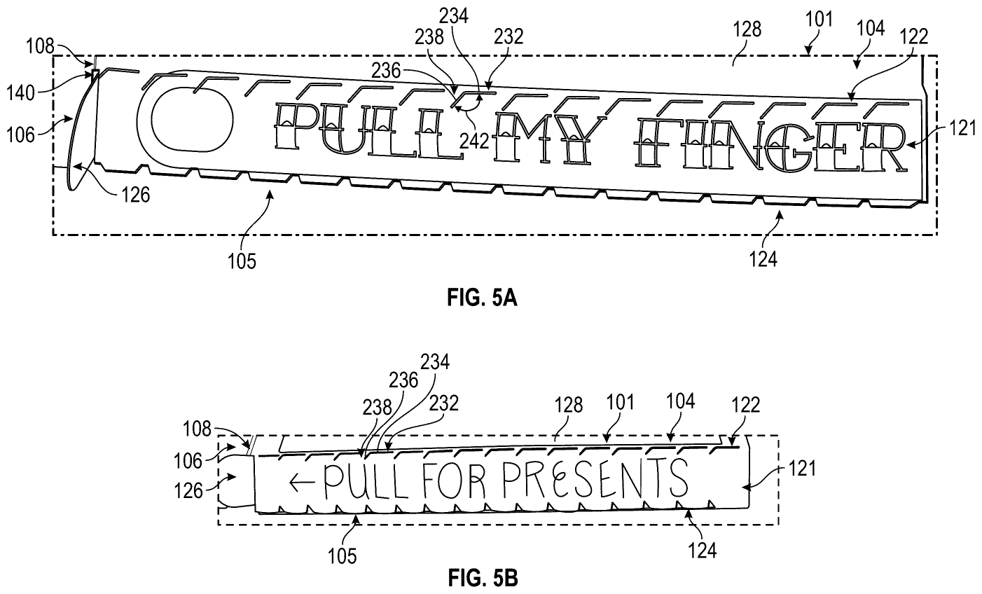

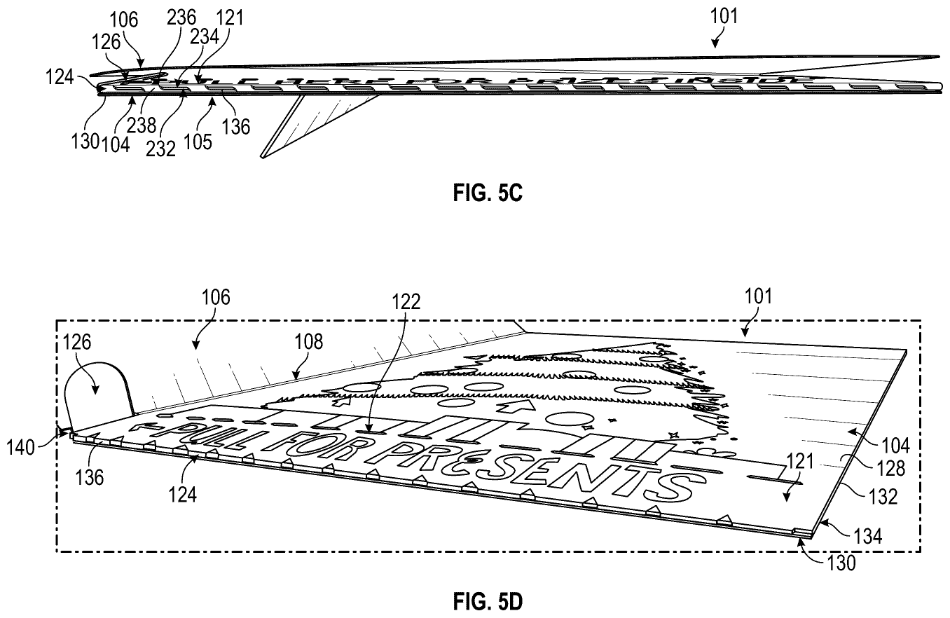

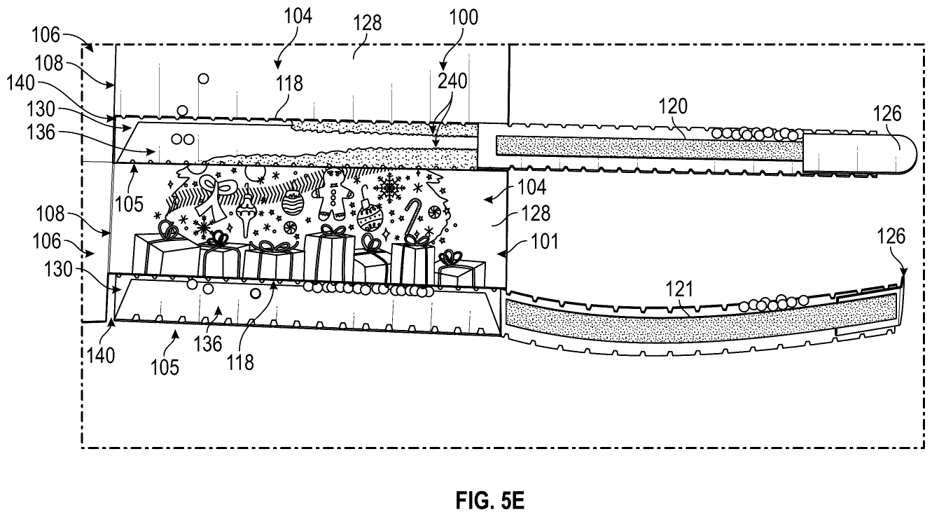

In some variants, the greeting card 100 can include a removable portion 120 with cross-cut perforations. For example, FIG. 5A-5D illustrate a greeting card 101, which can include any of the features of the greeting card 100, with a removable portion 121, which can include any of the features of the removable portion 120, that is coupled to the back panel 104 with cross-cut perforations. The removable portion 121 can include an upper perforation 122 and a lower perforation 124 coupling the removable portion 121 to the back panel 104 (e.g., inner wall 128 and intermediate layer 136). The lower perforation 124 can be disposed at the bottom edge 105 of the back panel 104. The upper perforation 122 and/or lower perforation 124 can include a cross-cut perforation. For example, the upper perforation 122 and/or lower perforation 124 can include a plurality of perforations 232, which can extend along the length of the removable portion 121 (e.g., from one lateral edge of the back panel 104 to the other lateral edge). The perforations 232 can be cuts (e.g., slits) and/or thinned portions to facilitate tearing along a predetermined path. Each of the perforations 232 can include a horizontal portion 234 and an angled portion 236. The horizontal portion 234 can be oriented parallel to the bottom edge 105. The horizontal portion 234 can be oriented perpendicular relative to the fold line 108 and/or lateral edges of the back panel 104. The angled portion 236 can extend from the horizontal portion 234 (e.g., be connected to). The angled portion 236 can extend from an end of the horizontal portion 234. The angled portion 236 can oriented at an angle 242 (e.g., obtuse angle) relative to the horizontal portion 234. The angle 242 can at least be 95, 100, 105, 110, 115, 120, 125, 130, 135, 140, 145, 150, 155, 160, 165, 170, or 175 degrees or any value between any of the foregoing. A connection 238, which can also be referred to as a bridge and/or link, can span between (e.g., separate) adjacent perforations 232. In some variants, the angled portion 236 of one perforation 232 may not extend past an end of a horizontal portion 234 of an adjacent perforation 232. In some variants, the perforations 232 of the upper perforation 122 and lower perforation 124 can be in a mirrored arrangement relative to a center longitudinal axis of the removable portion 121. In some variants, the perforations 232 are the same shape and/or size. In some variants, the perforations 232 can vary in shape and/or size.

During testing, the cross-cut perforations of the removable portion 121 of the greeting card 101 performed better than the perforations of the removable portion 120 of the greeting card 100. For example, the cross-cut perforations of the removable portion 121 separated more cleanly than the perforations of the removable portion 120 on a regular basis, which cleared the path for the one or more concealed objects to spill out of the interior 118 of the back panel 104. As shown in FIG. 5E, the removable portion 120, when separated at the perforations from the back panel 104, can leave a remainder 240 (e.g., lip) that can obstruct a fall path of the one or more objects concealed within a pouch disposed in the interior 118 of the back panel 104, which can make the spilling of the one or more objects less voluminous and/or dramatic. As shown in FIG. 5E, the removable portion 121 can be cleanly separated from the back panel 104 at the cross-cut perforations, which can provide an unobstructed fall path for the one or more objects concealed within the interior 118 of the back panel 104.

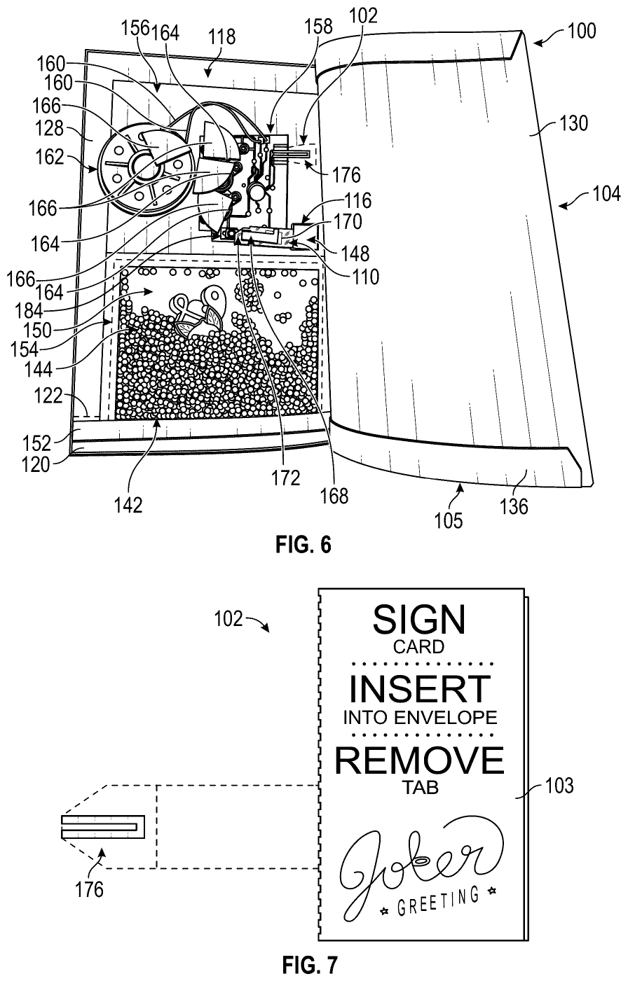

FIG. 6 illustrates the inner wall 128 and outer wall 130 of the back panel 104 separated to show internal components 156 of the greeting card 100. The internal components 156 can be disposed within the back panel 104 (e.g., inside the interior 118 of the back panel 104).

The internal components 156 can include a pouch 150 or other receptacle. The pouch 150, as illustrated, can hold the one or more objects 144. The pouch 150 can be coupled (e.g., adhered) to the inner wall 128. For example, an adhesive (e.g., adhesive strip, tape, double-sided tape, glue, etc.) can be disposed at a periphery 154 of the pouch 150 to adhere the pouch 150 to the inner wall 128. The adhesive can, in some variants, not be disposed at the upper perforation 122 to ease tearing by the user. In some variants, the pouch 150 can be coupled (e.g., adhered) to the outer wall 130. The bottom portion 142 of the pouch 150 can be coupled to the removable portion 120. For example, an adhesive component 152 (e.g., adhesive strip, tape, etc.) can couple the bottom portion 142 of the pouch 150 to the removable portion 120. For example, the adhesive component 152 can be disposed below the upper perforation 122 to couple the bottom portion 142 of the pouch 150 to the removable portion 120. The pouch 150 can be made of a material that can be torn by a recipient of average strength by pulling the removable portion 120 with moderate exertion. The pouch 150 can be a variety of shapes, which can include rectangular, square, etc.

The internal components 156 can include a loudspeaker 162. The loudspeaker 162 can be coupled (e.g., adhered) to the inner wall 128. In some variants, the loudspeaker 162 can be coupled (e.g., adhered) to an interior surface of the outer wall 130. The loudspeaker 162 can include one or more protective features, such as a housing or the like, to avoid damage to sensitive internal components.

The internal components 156 can include a controller 158, which can also be referred to as a module, electrical board, and/or electrical circuitry. The controller 158 can control the loudspeaker 162 as described herein. The controller 158 can cause the loudspeaker 162 to emit the audible sound or cease emitting the audible sound. The controller 158 can be operatively connected to the loudspeaker 162 by way of one or more wires 160. The one or more wires 160 can deliver power from the controller 158 to the loudspeaker 162. The controller 158 can include one or more batteries 164 (e.g., one, two, three, four or more) that can power the controller 158 and/or loudspeaker 162.

The internal components 156 can include one or more pieces of padding 166. The padding 166 can help protect at least some of the internal components 156. For example, padding 166 can be disposed on the loudspeaker 162, one or more batteries 164, and/or other electronic equipment (e.g., board, circuits, etc.). The padding 166 can be disposed between the outer wall 130 and the loudspeaker 162, one or more one or more batteries 164, and/or other electronic equipment.

The internal components 156 can include a conductor 176 (e.g., removable circuit piece, circuit piece, loop, conductor loop) of the operational switch 102. The conductor 176 can be coupled to the controller 158 (e.g., circuit of the controller 158). The conductor 176 can interface with the electronics of the controller 158. With the conductor 176 interfaced with the controller 158 (e.g., the operational switch 102 coupled to the greeting card 100), the greeting card 100 (e.g., controller 158) can be in a safe mode of operation in which opening the greeting card 100 causes the loudspeaker 162 to start emitting an audible sound and closing the greeting card 100 causes the loudspeaker 162 to cease emitting the audible sound. With the conductor 176 not interfaced with the controller 158 (e.g., the operational switch 102 decoupled from the greeting card 100 as shown in FIG. 7), the greeting card 100 (e.g., controller 158) can be in an armed, recipient, and/or prank mode in which initially opening the greeting card 100 causes the loudspeaker 162 starting to emit an audible sound but closing the greeting card 100 may not cause the loudspeaker 162 to cease emitting the audible sound such that a recipient, after opening the greeting card 100, may not be able to stop the loudspeaker 162 from emitting the audible sound for a duration of time (e.g., until the one or more batteries 164 are expended). The one or more batteries can be expended when the one or more batteries can no longer power the controller 158 and/or loudspeaker 162. The one or more batteries can be expended when the electrical current supplied by the one or more batteries reaches a lower threshold.

The controller 158 can include a switch 184, which can also be referred to as a secondary switch. The switch 184 can be operatively connected to the circuitry of the controller 158. With the operational switch 102 (e.g., primary operational switch) still coupled to the greeting card 100, the switch 184 can, when the greeting card 100 is opened or closed, cause the controller 158 to start or stop the loudspeaker 162 emitting audible sound. The switch 184 can include an arm 168, which can also be described as a conductor, member, and/or element. The arm 168 can contact (e.g., be biased to contact) an electrical contact 170 of the controller 158 to enable an electrical current to flow through the arm 168 to the electrical contact 170. With the operational switch 102 coupled to the opened greeting card 100, the switch 184 can cause the controller 158 to emit audible sound by way of the loudspeaker 162 with the arm 168 contacting the electrical contact 170. With the operational switch 102 coupled to the closed greeting card 100, the switch 184 can cause the controller 158 to not emit audible sound by way of the loudspeaker 162 with the arm 168 not contacting the electrical contact 170.

The switch 184 can include the member 110, which can be referred to as an electrical insulator, that can be disposed between the arm 168 and the electrical contact 170 to selectively impede electrical current flowing from the arm 168 to the electrical contact 170. With the greeting card 100 closed, the member 110 can be disposed between the arm 168 and the electrical contact 170 to impede electrical current from flowing from the arm 168 to the electrical contact 170. With the greeting card 100 opened, the member 110 can be positioned to not be disposed between the arm 168 and the electrical contact 170 to permit electrical current to flow from the arm 168 to the electrical contact 170. If the operational switch 102 is still coupled to the greeting card 100 (e.g., safe mode), the electrical current flowing from the arm 168 to the electrical contact 170 can cause the controller 158 to emit the audible sound by way of the loudspeaker 162. If the operational switch 102 is still coupled to the greeting card 100 (e.g., safe mode), a lack of electrical current flowing from the arm 168 to the electrical contact 170 may cause the controller 158 to not emit (e.g., stop emitting) the audible sound by way of the loudspeaker 162. If the operational switch 102 is not coupled to the greeting card 100 (e.g., armed, prank, and/or recipient mode), a lack of electrical current flowing from the arm 168 to the electrical contact 170 may not stop the controller 158 from causing the loudspeaker 162 to emit the audible sound. If the operational switch 102 is not coupled to the greeting card 100 (e.g., armed, prank, and/or recipient mode), an initial flow of electrical current flowing from the arm 168 to the electrical contact 170 may cause the controller 158 to start emitting the audible sound by way of the loudspeaker 162 despite subsequently blocking the flow of electrical current from the arm 168 to the electrical contact 170.

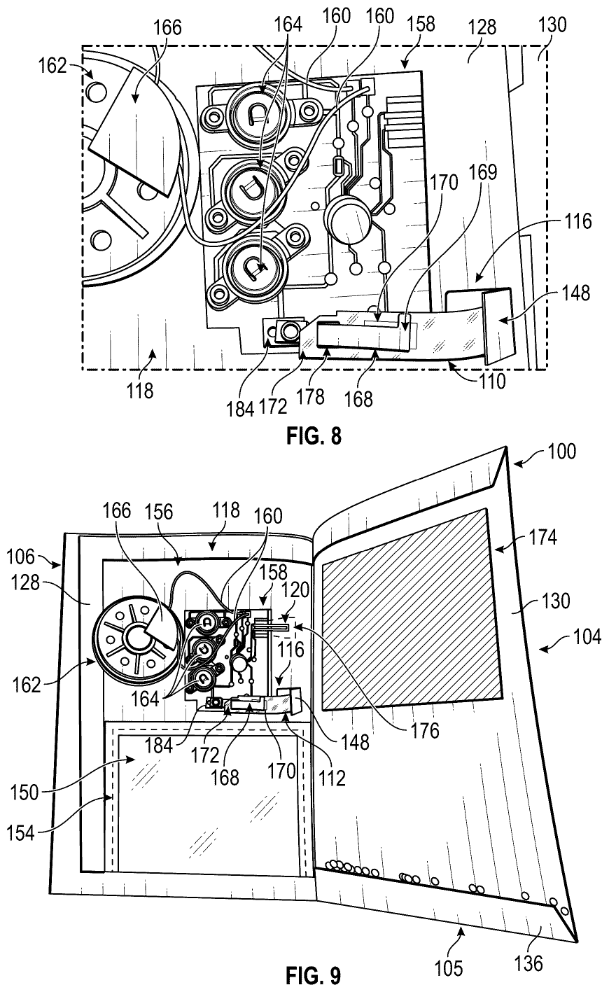

The member 110 can be coupled (e.g., slidably coupled) to the arm 168. As described herein and shown in FIG. 8, the member 110 can extend through the opening 116 of the back panel 104 (e.g., inner wall 128 of the back panel 104) into the interior 118 of the back panel 104. The inner wall 128 can include a flap 148, which can be formed in the inner wall 128, that opens to permit the member 110 to pass through the opening 116. The member 110 can include a second portion 172. The second portion 172 can be disposed within the interior 118 of the back panel 104. The second portion 172 can be disposed opposite the first portion 112. The member 110 can include an opening 178, which can be disposed at the second portion 172. The arm 168 can extend through the opening 178. With the greeting card 100 closed, the member 110 can separate the arm 168 and the electrical contact 170 to impede electrical flow. For example, the opening 178 of the member 110 can be positioned away from the electrical contact 170 to impede contact between the arm 168 and the electrical contact 170 as illustrated in FIG. 8. With the greeting card 100 opened, the member 110 can be pulled through opening 116 in the inner wall 128 of the back panel 104 to position the opening 178 of the member 110 at the electrical contact 170 to permit the arm 168 to contact the electrical contact 170 to permit electrical flow from the arm 168 to the electrical contact 170. The arm 168 can include a flange 169 (e.g., hook, member, and/or projection) that can impede the member 110 from being unintentionally decoupled (e.g., pulled off) the arm 168.

FIG. 9 illustrates the internal components 156 of the greeting card 100 with the pouch 150 opened (e.g., torn open) and emptied of the one or more objects. As described herein, the removable portion 120 can be coupled (e.g., adhered) to the bottom portion 142 of the pouch 150 such that, when the removable portion 120 is separated (e.g., torn) from the back panel 104, the bottom portion 142 is opened, which can include tearing the bottom portion 142 from the pouch 150, to permit the one or more objects to spill out. Adhesive can couple the periphery 154 of the pouch 150 to the inner wall 128 of the back panel 104. As described herein, adhesive, in some variants, may not be applied to the upper perforation 122 and/or lower perforation 124. In some variants, the pouch 150 can be coupled (e.g., adhered) to the outer wall 130 of the back panel 104.

In some variants, the greeting card 100 can include a pouch 174 or other receptacle, which can be referred to as a secondary pouch, as illustrated in FIG. 9. The pouch 174 can be concealed from view. The pouch 174 can hold one or more objects. The pouch 174 can be opened (e.g., ripped open) to spill one or more objects therefrom. In some variants, the pouch 174 can be placed within the interior 118 of the back panel 104 such that the pouch 174 can be opened (e.g., ripped open) and spill out one or more objects should the recipient of the greeting card 100 attempt to destroy (e.g., rip) the greeting card 100 in an effort to stop the loudspeaker 162 from emitting the audible sound. The pouch 174 can be disposed proximate the loudspeaker 162 and/or controller 158. The pouch 174 can be coupled (e.g., adhered) to the inner wall 128 and/or outer wall 130. The pouch 174 can be made of the same or similar material as the pouch 150.

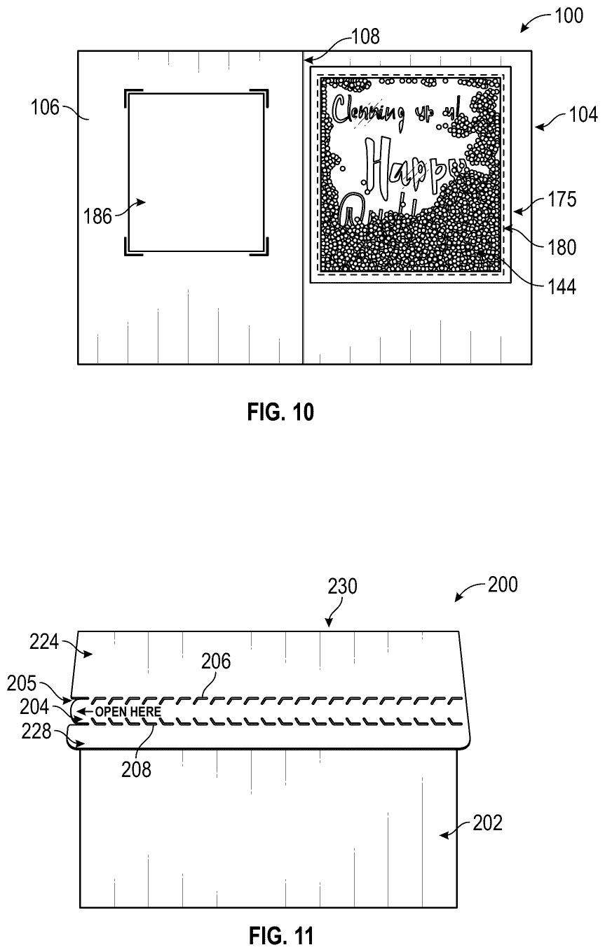

In some variants, the greeting card 100 can include a pouch 175 or other receptacle, which can be referred to as a secondary or tertiary pouch, as illustrated in FIG. 10. The pouch 175 can hold one or more objects 144. The pouch 175 can be coupled (e.g., adhered) to the back panel 104. A periphery 180 of the pouch 175 can be adhered to the back panel 104. In some variants, the pouch 175 can be adhered to the front panel 106.

The pouch 175 can be configured to open (e.g., rip open) when the recipient opens the greeting card 100 (e.g., separates the front panel 106 and back panel 104) to spill the one or more objects 144 from the pouch 175. For example, the greeting card 100 can include an opening feature 186 (e.g., ripping feature and/or tearing feature) that is configured to open (e.g., rip open) the pouch 175 when the greeting card 100 is opened. The opening feature 186 can be disposed on a front panel 106 opposite the pouch 175. The opening feature 186 can be positioned to open a bottom portion of the pouch 175. The opening feature 186 can interface with the pouch 175 with the greeting card 100 closed, and when the greeting card 100 is being opened, open (e.g., rip open) the pouch 175 to spill out the one or more objects 144. The opening feature 186 can include an adhesive component (e.g., tape, double sided tape). The adhesive component can be adhered to the front panel 106 and the pouch 175. When the greeting card 100 is being opened, the adhesive component can tear open the pouch 175 to spill out the one or more objects 144. The opening feature 186 can include a hook, projection, member, and/or other feature that can engage (e.g., puncture, hook, couple to) the pouch 175 with the greeting card 100 closed and rip open the pouch 175 when the greeting card 100 is opened. In some variants, the pouch 175 can include a removable portion, such as a tear strip, that can be coupled (e.g., adhered) to the front panel 106 such that, when the greeting card 100 is opened, the pouch 175 is opened (e.g., torn open) as the removable portion is separated from the pouch 175. In some variants, the opening feature 186 can be coupled to the back panel 104.

FIG. 11 illustrates an envelope 200. The envelope 200 can include one or more hidden features to prank a recipient of the envelope 200. In some variants, the greeting card 100 can be disposed inside of the envelope 200 to deliver (e.g., mail) to a recipient. In some variants, another greeting card or the like can be disposed inside of the envelope 200 to deliver to a recipient. The envelope 200 can include a receptacle portion 202 that can receive the greeting card 100 or other greeting cards or the like.

The envelope 200 can include a flap 224. One end of the flap 224 can be connected to the receptacle portion 202 with a hinge 230 (e.g., fold). The flap 224 can be rotated about the hinge 230 to open or close. The flap 224 can be moved to an open position (e.g., rotated away from the receptacle portion 202) to access an interior of the receptacle portion 202. The flap 224 can be moved to a closed position (e.g., shut, rotated towards the receptacle portion 202) to temporarily impede access into the interior of the receptacle portion 202 and/or maintain the greeting card 100 or another greeting card within the receptacle portion 202. The flap 224 can be adhered in the closed configuration. For example, the flap 224 can be adhered to the receptacle portion 202 to maintain the flap 224 in the closed configuration. The flap 224 can include a coupling portion 228, which can also be referred to as a fixing, adhering, and/or securing portion. The coupling portion 228 can be coupled (e.g., adhered) to the receptacle portion 202 to maintain the flap 224 in the closed configuration. The coupling portion 228 can be disposed at an end portion (e.g., free end portion) of the flap 224.

The flap 224 can include a removable portion 204 (e.g., tear strip). The removable portion 204 can be disposed between the coupling portion 228 and the hinge 230. With the flap 224 adhered in the closed position (e.g., the coupling portion 228 adhered to the receptacle portion 202), the removable portion 204 can be separated (e.g., torn) from the flap 224 to free the remainder of the flap 224 to move (e.g., rotate) to an open position to access an interior of the envelope 200 (e.g., receptacle portion 202). The separate (e.g., tearing) of the removable portion 204 from the flap 224 can permit one or more concealed objects (e.g., glitter, confetti, stickers, press-on tattoos, candy, ribbons, sheets with printed messages and/or images, toys, etc.) to spill out. For example, a pouch (e.g., concealed pouch) or other receptacle can be disposed on an inside surface of the flap 224 such that separating the removable portion 204 from the flap 224 opens (e.g., tears open) the pouch to permit the one or more concealed objects to spill out. The removable portion 204 can span from one lateral side of the flap 224 to the other. The removable portion 204 can include a grasping portion 205 (e.g., tab, flange, flap). The grasping portion 205 can be disposed at an end portion (e.g., edge) of the removable portion 204. The grasping portion 205 can include a rounded shape, which can decrease a likelihood that the grasping portion 205 will inadvertently catch on something and prematurely separate the removable portion 204 from the flap 224. The removable portion 204 can include instructions directing the recipient of the envelope 200 to decouple the removable portion 204 form the flap 224 which can include pulling the grasping portion 205.

The removable portion 204 can include one or more perforations to ease decoupling from the flap 224. For example, the removable portion 204 can include a first perforation 206 and/or a second perforation 208. The first perforation 206 can be disposed between the removable portion 204 and the hinge 230. The second perforation 208 can be disposed between the removable portion 204 and the coupling portion 228. The first perforation 206 and/or second perforation 208 can span from one lateral side of the flap 224 to the other. The first perforation 206 and second perforation 208 can be oriented parallel relative to each other.

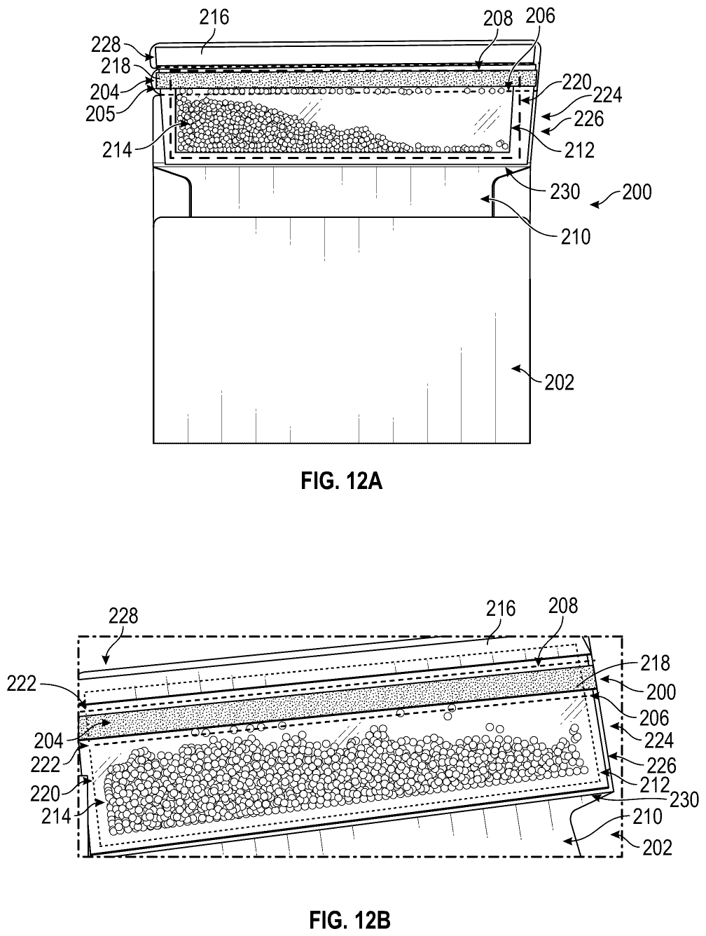

As shown in FIG. 12A, a pouch 212 or other receptacle can be disposed on an underside 226 of the flap 224. The pouch 212 can hold one or more objects 214 objects (e.g., glitter, confetti, stickers, press-on tattoos, candy, ribbons, sheets with printed messages and/or images, toys, etc.). The pouch 212 can be varying shapes and/or sizes, which can include rectangular. The pouch 212 can be made of a material that can be torn by a user of average strength with moderate exertion. The pouch 212 can, in some variants, not be coupled (e.g., adhered) to the coupling portion 228. The pouch 212 can be coupled to the removable portion 204. An adhesive component 220 (e.g., adhesive, tape, double-sided adhesive) can be disposed at a periphery of the pouch 212 to adhere the pouch 212 to the flap 224, which can include the removable portion 204. In some variants, the adhesive component 220 can include a rectangular shape to adhere a periphery of the pouch 212 to the underside 226 of the flap 224. However, disposing adhesive, such as the adhesive component 220, at the first perforation 206 and/or second perforation 208 can provide too much resistance to separation forces (e.g., pull forces) applied to the removable portion 204, which can prevent a recipient from quickly separating the removable portion 204 and/or slow down separation to an extent that impedes dramatic separation with the accompanying immediate spilling out of the one or more objects 214. Accordingly, to improve separation, one or more gaps 222 in the adhesive component 220 can be disposed at the first perforation 206 and/or second perforation 208 to ease separation of the removable portion 204 form the 224, as illustrated in FIG. 12B. The one or more one or more gaps 222 in the adhesive component 220 can enable the removable portion 204 to be pulled across the envelope 200 to separate at the first perforation 206 and/or second perforation 208 with reduced resistance, which can improve the recipient experience. For example, gaps 222 in the application of the adhesive component 220 can be disposed at the first perforation 206 and/or second perforation 208. With a portion of the pouch 212 adhered to the removable portion 204, the pouch 212 can be ripped open when the removable portion 204 is separated from the flap 224 to allow the one or more objects 214 to spill out from the pouch 212. For example, the pouch 212 can be ripped open at a position proximate the first perforation 206 as the removable portion 204 is separated from the flap 224.

An adhesive component 216 (e.g., adhesive, tape, double-sided adhesive) can be disposed on an underside of the coupling portion 228. The adhesive component 216 can adhere the coupling portion 228 to the receptacle portion 202 to close an opening 210 into the receptacle portion 202. The adhesive component 216 can include a cover that can be removed to expose adhesive to adhere the coupling portion 228 to the receptacle portion 202.

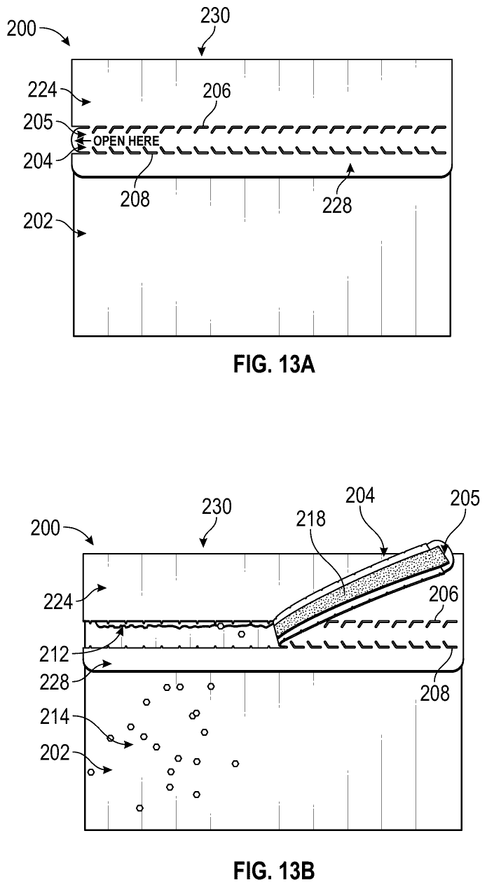

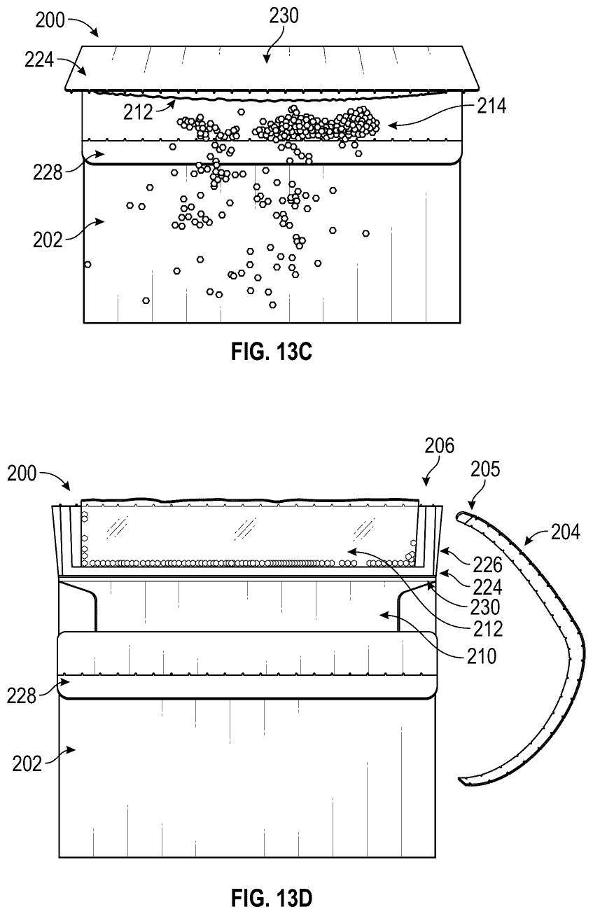

In use, the greeting card 100 or another greeting card or the like can be disposed into the receptacle portion 202 by way of the opening 210. A cover disposed on the adhesive component 216 can be removed to expose adhesive of the adhesive component 216. The flap 224 can be rotated down to bring the adhesive component 216 into contact with the receptacle portion 202 to adhere the coupling portion 228 to the receptacle portion 202 which can maintain the flap 224 in the closed position as illustrated in FIG. 13A. The envelope 200 with the greeting card 100 or another greeting card or the like can be delivered (e.g., mailed) to a recipient. The recipient can grasp the grasping portion 205 and separate the removable portion 204 from the flap 224, which can include tearing along the first perforation 206 and second perforation 208. As the recipient separates the removable portion 204 from the flap 224, the pouch 212 can be opened (e.g., ripped open) to permit the one or more objects 214 to spill out as illustrated in FIG. 13B. The recipient can continue separating (e.g., pulling) the removable portion 204 until completely separated from the flap 224. With the removable portion 204 completely separated from the flap 224, the contents of the pouch 212 can be emptied. With the removable portion 204 separated from the flap 224, the remainder of the flap 224 is decoupled from the coupling portion 228. With the removable portion 204 separated from the flap 224, the remainder of the flap 224 can be rotated open (e.g., rotated away from the receptacle portion 202) to enable the recipient to access an interior of the receptacle portion 202 through the opening 210 as illustrated in FIG. 13D. The coupling portion 228 can remain coupled (e.g., adhered) to the receptacle portion 202. As shown, the pouch 212 can be torn open at the first perforation 206. The pouch 212 can be torn from one lateral edge to the other. The pouch 212 can be substantially emptied of the one or more objects 214. In some variants, the pouch 212 can be disposed within the flap 224, which can include being disposed between an inner wall and an outer wall of the flap 224.

In general, the word “controller,” as used herein, refers to logic embodied in hardware or firmware, or to a collection of software instructions, possibly having entry and exit points, written in a programming language, such as, for example, Java, C or C++. A software controller may be compiled and linked into an executable program, installed in a dynamic link library, or may be written in an interpreted programming language such as, for example, BASIC, Perl, or Python. It will be appreciated that controllers can include software modules that may be callable from other modules or from themselves, and/or may be invoked in response to detected events or interrupts. Software instructions may be embedded in firmware, such as an EPROM. It will be further appreciated that hardware controllers may be comprised of connected logic units, such as gates and flip-flops, and/or may be comprised of programmable units, such as programmable gate arrays or processors. The controllers described herein may be represented in software, hardware, or firmware. Generally, the controllers described herein can include logical modules that may be combined with other modules or divided into sub-modules despite their physical organization or storage.

The various illustrative logical blocks, controllers, data structures, and processes described herein may be implemented as electronic hardware, computer software, or combinations of both. To clearly illustrate this interchangeability of hardware and software, various illustrative components, blocks, modules, and states have been described above generally in terms of their functionality. However, while the various modules are illustrated separately, they may share some or all of the same underlying logic or code. Certain of the logical blocks, controllers, and processes described herein may instead be implemented monolithically.

The various illustrative logical blocks, modules, data structures, and processes described herein may be implemented or performed by a machine, such as a computer, a processor, a digital signal processor (DSP), an application specific integrated circuit (ASIC), a filed programmable gate array (FPGA) or other programmable logic device, discrete gate or transistor logic, discrete hardware components, or any combination thereof designed to perform the functions described herein. A processor may be a microprocessor, a controller, a microcontroller, a state machine, combinations of the same, or the like.

Depending on the embodiment, certain acts, events, or functions of any of the processes or algorithms described herein can be performed in a different sequence, may be added, merged, or left out altogether. Thus, in certain embodiments, not all described acts or events are necessary for the practice of the processes. Moreover, in certain embodiments, acts or events may be performed concurrently, e.g., through multi-threaded processing, interrupt processing, or via multiple processors or processor cores, rather than sequentially.

It should be appreciated that in the above description of embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim require more features than are expressly recited in that claim. Moreover, any components, features, or steps illustrated and/or described in a particular embodiment herein can be applied to or used with any other embodiment(s). Thus, it is intended that the scope of the inventions herein disclosed should not be limited by the particular embodiments described above.

What is claimed is:

1. A greeting card configured to permit one or more concealed objects to spill out therefrom in response to a recipient of the greeting card separating a tear strip from a panel of the greeting card, the greeting card comprising:
a first panel;
a second panel rotatably coupled to the first panel, the second panel comprising an inner wall, an outer wall, and an interior disposed between the inner wall and the outer wall;
a tear strip coupled to the inner wall with an upper perforation and a lower
perforation, each of the upper perforation and the lower perforation comprising cross-cut perforations, and the lower perforation disposed at a bottom edge of the second panel; and
a pouch comprising one or more objects, the pouch disposed within the interior of the second panel and coupled to the tear strip;
wherein the tear strip is configured to be grasped and separated from the second panel by a recipient of the greeting card such that the pouch tears open to permit the one or more objects to spill out downward substantially unobstructed by the greeting card.

2. The greeting card of claim 1, wherein the tear strip comprises a grasping portion configured to be grasped by the recipient.

3. The greeting card of claim 1, further comprising an adhesive component adhering a bottom portion of the pouch to the tear strip.

4. The greeting card of claim 3, wherein the adhesive component is not applied at the upper perforation.

5. The greeting card of claim 3, wherein the adhesive component is not applied at the lower perforation.

6. The greeting card of claim 1, further comprising an intermediate layer disposed at the bottom edge of the second panel between the inner wall and the outer wall.

7. The greeting card of claim 6, wherein the lower perforation couples a bottom edge of the intermediate layer to a bottom edge of the inner wall.

8. The greeting card of claim 1, wherein each of the cross-cut perforations comprises a horizontal portion and an angled portion.

9. The greeting card of claim 8, wherein the angled portion extends from an end of the horizontal portion at an obtuse angle.

10. The greeting card of claim 1, further comprising a loudspeaker, a controller operatively connected to the loudspeaker, a battery configured to provide electrical power to the controller and the loudspeaker, and a switch coupled to the first panel and the second panel, wherein the controller is configured to be operable in a safe mode and a recipient mode, and wherein rotating the first panel with respect to the second panel causes the switch to move between a first state and a second state.

11. The greeting card of claim 10, wherein with the controller in the safe mode, the controller is configured to start emitting a recorded sound by way of the loudspeaker when the switch moves from the first state to the second state and stop emitting the recorded sound when the switch moves from the second state to the first state, and wherein with the controller in the recipient mode, the controller is configured to start emitting the recorded sound by way of the loudspeaker when the switch moves from the first state to the second state and continue emitting the recorded sound when the switch moves from the second state to the first state until the battery is expended.

12. The greeting card of claim 11, wherein the first panel and second panel are in an open configuration with the switch in the first state and the first panel and second panel are in a closed configuration with the switch in the second state.

13. The greeting card of claim 10, wherein the controller is configured to switch only once from the safe mode to the recipient mode.

14. The greeting card of claim 10, further comprising an operational switch configured to be manipulated by a user to switch the controller from the safe mode to the recipient mode such that the controller cannot be switched from the recipient mode back to the safe mode.

15. A greeting card configured to prank a recipient, the greeting card comprising:
a first panel;
a second panel coupled to the first panel, the second panel comprising an interior concealed from view;
a removable portion, the removable portion coupled to the second panel with a first perforation and a second perforation, each of the first perforation and the second perforation comprising cross-cut perforations, the cross-cut perforations comprising a horizontal portion and an angled portion extending from an end of the horizontal portion at an angle, and the second perforation disposed at a bottom edge of the second panel; and
a pouch comprising one or more objects, the pouch disposed within the interior of the second panel and coupled to the removable portion;
wherein the removable portion is configured to be grasped and separated from the second panel by the recipient of the greeting card to open the pouch to permit the one or more objects to spill out.

16. The greeting card of claim 15, wherein the removable portion is configured to be grasped and separated from the second panel by the recipient of the greeting card to tear open the pouch.

17. The greeting card of claim 15, further comprising a loudspeaker, a controller operatively connected to the loudspeaker, a battery configured to provide electrical power to the controller and the loudspeaker, and a switch coupled to the first panel and the second panel, wherein the controller is configured to be operable in a safe mode and a recipient mode, and wherein rotating the first panel with respect to the second panel causes the switch to move between a first state and a second state.

18. The greeting card of claim 17, wherein with the controller in the safe mode, the controller is configured to start emitting a recorded sound by way of the loudspeaker when the switch moves from the first state to the second state and stop emitting the recorded sound when the switch moves from the second state to the first state, and wherein with the controller in the recipient mode, the controller is configured to start emitting the recorded sound by way of the loudspeaker when the switch moves from the first state to the second state and continue emitting the recorded sound when the switch moves from the second state to the first state until the battery is expended.

19. An envelope configured to prank a recipient, the envelope comprising:
a receptacle portion comprising an opening into an interior configured to receive a greeting card; and
a flap rotatably coupled to the receptacle portion;
a removable portion coupled to the flap with a first perforation and a second perforation;
a pouch comprising one or more objects, the pouch disposed on an underside of the flap and an underside of the removable portion; and
an adhesive component adhering the pouch to the undersides of the flap and the removable portion, wherein a first gap in the adhesive component is disposed at the first perforation to ease separation of the removable portion from the flap;
wherein the removable portion is configured to be grasped and separated from the flap by a recipient of the envelope such that the pouch is opened to permit the one or more objects to spill out.

20. The envelope of claim 19, wherein a second gap in the adhesive component is disposed at the second perforation to ease separation of the removable portion from the flap.
